(19) United States
(12) Patent Application Publication
(10) Pub. No.: US 2012/0269479 A1
(43) Pub. Date: Oct. 25, 2012

(54) OPTICAL MODULE

(75) Inventor: Norio Okada, Tokyo (JP)

(73) Assignee: Mitsubishi Electric Corporation, Tokyo (JP)

(21) Appl. No.: 13/239,712

(22) Filed: Sep. 22, 2011

(30) Foreign Application Priority Data
Apr. 25, 2011 (JP) 2011-097180

(51) Int. Cl. G02B 6/12; G02B 6/36

(52) U.S. Cl. 385/14; 385/88

(57) ABSTRACT

An optical module includes a metallic stem a lead pin penetrating through the metallic stem and electrically insulated from the metallic stem, an optical semiconductor element on the metallic stem and connected to a first end of the lead pin, and a flexible substrate including first and second signal lines. A first end of the first signal line is connected to a second end of the lead pin. A second end of the first signal line is connected to a first end of the second signal line. The lead pin has a penetrating portion penetrating through the metallic stem. Each of the penetrating portion and the second signal line has a smaller impedance than the impedance of the first signal line.

### BACKGROUND OF THE INVENTION

1. Field of the Invention

The present invention relates to a coaxial-type optical module wherein an optical semiconductor element is connected to a lead pin penetrating through a metallic stem.

2. Background Art

An optical module is used in an optical communications system which transmits optical signals via optical fibers. When the optical semiconductor element that requires temperature control is used in an optical module, it is required to form a temperature controlling element on a metallic stem, and to form an optical semiconductor element thereon. By maintaining the temperature of the optical semiconductor element using the temperature controlling element, the characteristics of the optical semiconductor element can be maintained constant. However, the lead pin must be elongated by the thickness of the temperature controlling element, or the wire for connecting the lead pin with the optical semiconductor element must be elongated.

### SUMMARY OF THE INVENTION

Impedance in the vicinity of the optical semiconductor element is close to the matching impedance of 50Ω at low frequencies. However, as approaching to high frequencies, the impedance departs from 50Ω due to the parasitic capacity or parasitic resistance of the optical semiconductor element, or the inductance of the wire. In addition, at the penetrating portion where the lead pin is penetrating through the metallic stem, the impedance of the lead pin is lower than 50Ω. Therefore, multiple reflection occurs between the optical semiconductor element and the penetrating portion. Although techniques for compensating the impedance of the penetrating portion in the vicinity of the penetrating portion are available (for example, refer to Japanese Patent Application Laid-Open No. 2006-128545), exact matching to 50Ω is difficult, and the constitution of the penetrating portion becomes specialized.

Furthermore, if the temperature controlling element is formed as described above, the electrical length between the optical semiconductor element and the lead pin is increased, and the phase of reflected signals shifts. When the phase shifts by 180 degrees, the reflected signals and the original signals negate with each other, and the gain is lowered. Since the wavelength changes depending on the frequency, the gain has periodicity with respect to the frequency, and the frequency response characteristics are deteriorated.

In view of the above-described problems, an object of the present invention is to provide an optical module which can obtain favorable frequency response characteristics.

According to the present invention, an optical module includes: a metallic stem; a lead pin penetrating through the metallic stem and insulated from the metallic stem; an optical semiconductor element on the metallic stem and connected to a first end of the lead pin; and a flexible substrate including first and second signal lines, wherein a first end of the first signal line is connected to a second end of the lead pin, a second end of the first signal line is connected to a first end of the second signal line, the lead pin has a penetrating portion penetrating through the metallic stem, and each of the penetrating portion and the second signal line has smaller impedance than impedance of the first signal line.

The present invention makes it possible to obtain favorable frequency response characteristics.

Other and further objects, features and advantages of the invention will appear more fully from the following description.

### BRIEF DESCRIPTION OF THE DRAWINGS

FIG. 1 is a diagram showing an optical module according to the first embodiment of the present invention.

FIG. 2 is a graph showing the relationship between the reflection waves of the first and second multiple reflections of the optical module according to the first embodiment of the present invention, and the frequency dependency on the amplitude of these synthetic waves.

FIG. 3 is a graph showing the frequency dependency of the response characteristics of optical modules in the first embodiment and the comparative example.

FIG. 4 is a diagram showing an optical module according to the second embodiment of the present invention.

FIG. 5 is a graph showing the relationship between the reflection waves of the first and second multiple reflections of the optical module according to the second embodiment of the present invention, and the frequency dependency on the amplitude of these synthetic waves.

FIG. 6 is a graph showing the frequency dependency of the response characteristics of optical modules in the second embodiment and the comparative example.

FIG. 7 is a diagram showing an optical module according to the third embodiment of the present invention.

FIG. 8 is a graph showing the frequency dependency of S (2, 1) of optical modules of the third embodiment and the comparative example.

FIG. 9 is a diagram showing an optical module according to the fourth embodiment of the present invention.

FIG. 10 is a graph showing the frequency dependency of response characteristics of an optical module according to the fourth embodiment of the present invention.

FIG. 11 is a diagram showing an optical module according to the fifth embodiment of the present invention.

FIG. 12 is a graph showing the frequency dependency of the response characteristics of an optical module according to the fifth embodiment of the present invention.

FIG. 13 is a graph showing the frequency dependency of the S11 of an optical module according to the fifth embodiment of the present invention.

### DETAILED DESCRIPTION OF THE PREFERRED EMBODIMENTS

An optical module according to the embodiments of the present invention will be described with reference to the drawings. The same components will be denoted by the same symbols, and the repeated description thereof may be omitted.

### First Embodiment

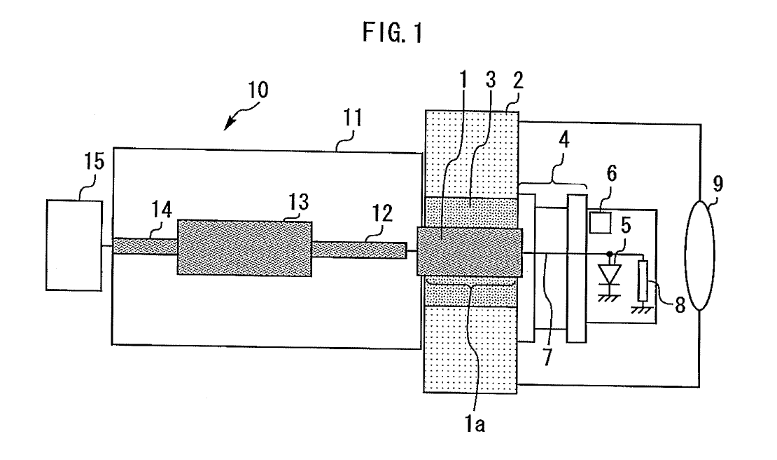

FIG. 1 is a diagram showing an optical module according to the first embodiment of the present invention. A lead pin 1 penetrates through a metallic stem 2, and is insulated from the metallic stem 2 by a glass insulator 3. A Peltier element 4 for controlling temperature is formed on the metallic stem 2. On the Peltier element 4, an electro-absorption optical modulator element 5 and a thermistor 6 for measuring temperature are formed. The electro-absorption optical modulator element 5 is connected to an end of the lead pin 1 by a wire 7. A matching resistor 8 is connected in parallel to the electro-absorption optical modulator element 5. These constituents are sealed in a cap 9 having a lens.

A flexible substrate 10 (flexible printed circuit) is formed on the back face of the metallic stem 2. The flexible substrate 10 has a dielectric base film 11, and signal lines 12, 13, and 14 formed on the base film 11. An end of the signal line 12 is soldered to the other end of the lead pin 1. The other end of the signal line 12 is connected to an end of the signal line 13. To the other end of the signal line 13, the signal line 14 is connected. To the signal line 14, a driving circuit 15 is connected. Electric modulation signals are transmitted from the driving circuit 15 to the signal lines 12, 13, and 14; the lead pin 1; and the electro-absorption optical modulator element 5 via the wire 7.

When the electro-absorption optical modulator element 5 is used, the resistance value of the matching resistor 8 is set to the vicinity of matching impedance of 50Ω. Here, the matching impedance is defined by the value of the terminating resistor of the driving circuit 15. The impedance of the signal lines 12 and 14 is also matched to 50Ω. The diameter of the glass insulator 3 is 0.8 to 1.0 mm, the diameter of the lead pin 1 is 0.25 to 0.35 mm, and the relative permittivity of the glass insulator 3 is about 6.0 to 7.0. Therefore, the impedance of the penetrating portion 1a penetrating through the metallic stem 2 of the lead pin 1 is approximately 20Ω.

Although impedance in the vicinity of the electro-absorption optical modulator element 5 is close to matching impedance of 50Ω at low frequencies, it departs from 50Ω due to the parasitic capacity or parasitic resistance of the electro-absorption optical modulator element 5, or the inductance of the wire 7 as approaching to high frequencies. For this reason, multiple reflection occurs between the electro-absorption optical modulator element 5 and the penetrating portion 1a (first multiple reflection).

In addition, when the electro-absorption optical modulator element 5 requiring temperature control is used, a Peltier element 4 is mounted on a metallic stem 2, and the electro-absorption optical modulator element 5 is formed thereon. Therefore, in comparison with the case when an optical semiconductor element operating without cooling is formed directly on the metallic stem 2, the electrical length from the lead pin 1 to the electro-absorption optical modulator element 5 is longer. For this reason, the phase of reflected signals shifts. When the phase shifts by 180 degrees, the reflected signals and the original signals negate with each other, and the gain is lowered. Since the wavelength changes depending on the frequency, the gain has periodicity with respect to the frequency, and the frequency response characteristics are deteriorated.

Therefore, in the present embodiment, the impedance of the signal line 13 is reduced than the matching impedance of 50Ω. Consequently, the impedance of the penetrating portion 1a and the signal line 13 is lower than the impedance of the signal line 12 or the terminating resistor of the driving circuit 15.

Thereby, multiple reflection occurs also between the electro-absorption optical modulator element 5 and the signal line 13 (second multiple reflection). The electrical length L2 between the electro-absorption optical modulator element 5 and the signal line 13 is longer than the electrical length L1 between the electro-absorption optical modulator element 5 and the penetrating portion 1a. Therefore, the period of the gain variation for the frequency due to the second multiple reflection becomes shorter than the period of the gain variation due to the first multiple reflection.

The synthetic wave of these two multiple reflections is represented as below:

A(f)×sin(2πf×L1)+B(f)×sin(2πf×L2)

Where, f denotes frequency, A (f) and B (f) denote reflection of each multiple reflection.

Although the reflections of the penetrating portion 1a and the signal line 13 are nearly constant for frequencies, the reflection around the electro-absorption optical modulator element 5 has frequency dependency, and is enlarged as the frequency becomes high. Therefore, reflections A (f) and B (f) also have frequency dependencies, and are enlarged as the frequency becomes high.

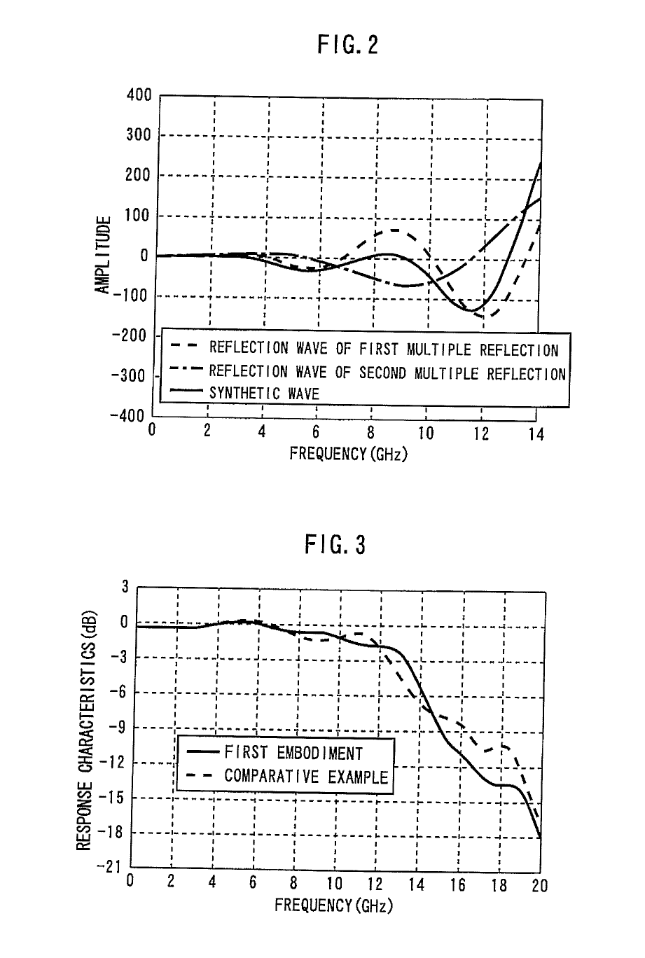

FIG. 2 is a graph showing the relationship between the reflection waves of the first and second multiple reflections of the optical module according to the first embodiment of the present invention, and the frequency dependency on the amplitude of these synthetic waves. FIG. 3 is a graph showing the frequency dependency of the response characteristics of optical modules in the first embodiment and the comparative example. The comparative example is the optical module from which signal lines 12 and 13 are omitted. It can be seen that although the swell of the frequency response characteristics occurs in the comparative example, it is reversed in the first embodiment. Therefore, favorable frequency response characteristics can be obtained by the first embodiment.

### Second Embodiment

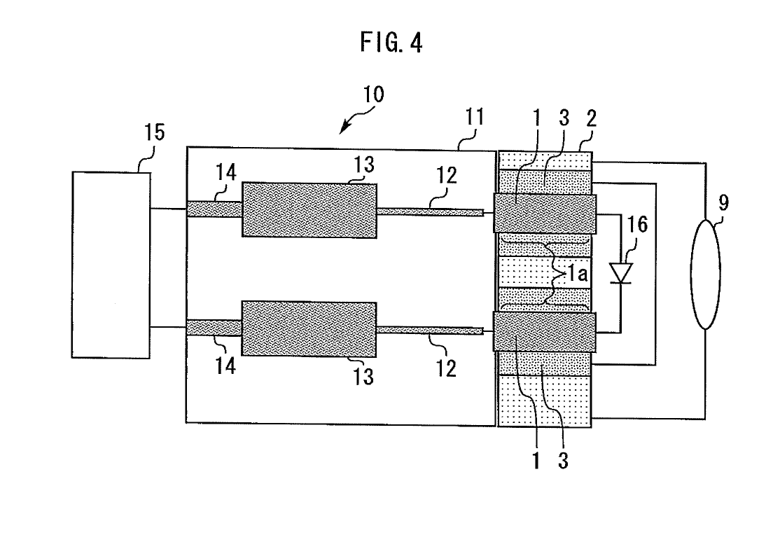

FIG. 4 is a diagram showing an optical module according to the second embodiment of the present invention. A direct modulation-type optical modulating element 16 is used in place of the electro-absorption optical modulator element 5 in the first embodiment. Since no temperature control is normally required, the direct modulation-type optical modulating element 16 is directly formed on the metallic stem 2. The impedance of the direct modulation-type optical modulating element 16 is approximately 7Ω.

Since efficiency or heat generation is suppressed when a direct modulation-type optical modulating element 16 that directly modulates with a current is used, it is frequently designed so as to be matched with impedance as low as possible. Generally, matching impedance is approximately 25Ω. Therefore, the mismatch of impedance in the penetrating portion 1a is not significant.

However, when the direct modulation-type optical modulating element 16 is used, since no matching resistor is formed in the vicinity of the direct modulation-type optical modulating element 16, matching cannot be achieved from low frequencies to high frequencies. In addition, peaking of frequency response characteristics or the drop of gain from low frequencies to several gigahertzes due to the relaxation oscillation frequency occurs, and optical output waveform is prone to be deteriorated.

In the second embodiment, therefore, the impedance of the signal line 12 is made to be higher than the matching impedance of 25Ω, and the impedance of the signal line 13 is made to be lower than 25Ω. The impedance of the signal line 14 and the terminating resistor of the driving circuit 15 are 25Ω.

Therefore, multiple reflection occurs between the direct modulation-type optical modulating element 16 and the signal line 12 (first multiple reflection), and multiple reflection occurs also between the direct modulation-type optical modulating element 16 and the signal line 13 (second multiple reflection). Since the electrical lengths of both the multiple reflections differ, the frequency cycles of the first and second multiple reflections differ.

Furthermore, the phase of reflection in the case of mismatching at low impedance differs by 180 degrees from the phase of reflection in the case of mismatching at high impedance. For this reason, the first multiple reflection and the second multiple reflection negate with each other at low frequencies. However, since the electrical lengths differ, the phases of the first multiple reflection and the second multiple reflection start overlapping one another at high frequencies. Since the gain is enhanced when the phases overlap initially by making the impedance of the signal lines 12 close to the metallic stem 2 high, and making the impedance of the signal lines 13 far from the metallic stem 2 low, the gain at high frequencies can be improved.

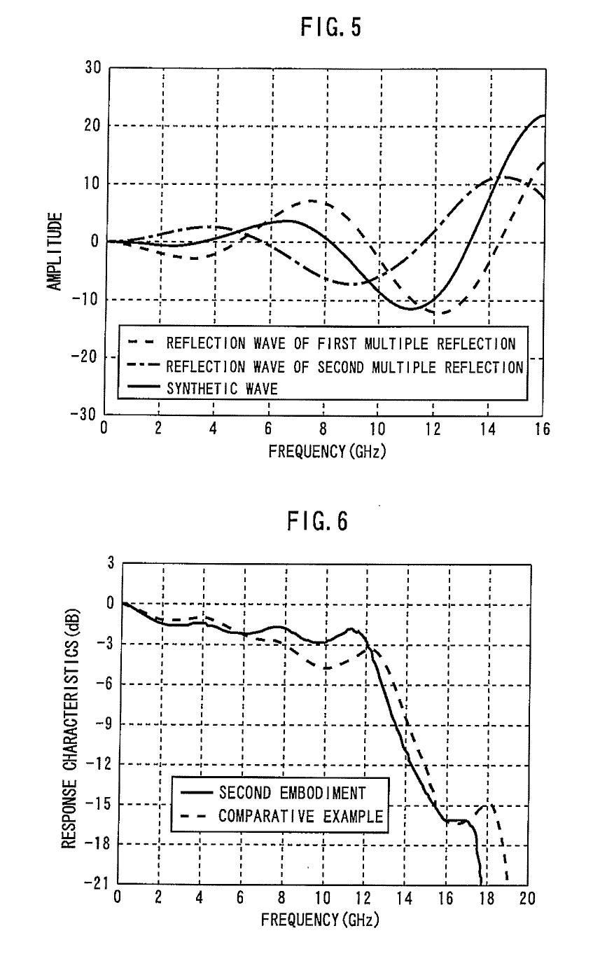

FIG. 5 is a graph showing the relationship between the reflection waves of the first and second multiple reflections of the optical module according to the second embodiment of the present invention, and the frequency dependency on the amplitude of these synthetic waves. FIG. 6 is a graph showing the frequency dependency of the response characteristics of optical modules in the second embodiment and the comparative example. The comparative example is the optical module from which signal lines 12 and 13 are omitted. In the second embodiment, since the gain at high frequencies can be improved in comparison with the comparative example, favorable frequency response characteristics can be obtained.

### Third Embodiment

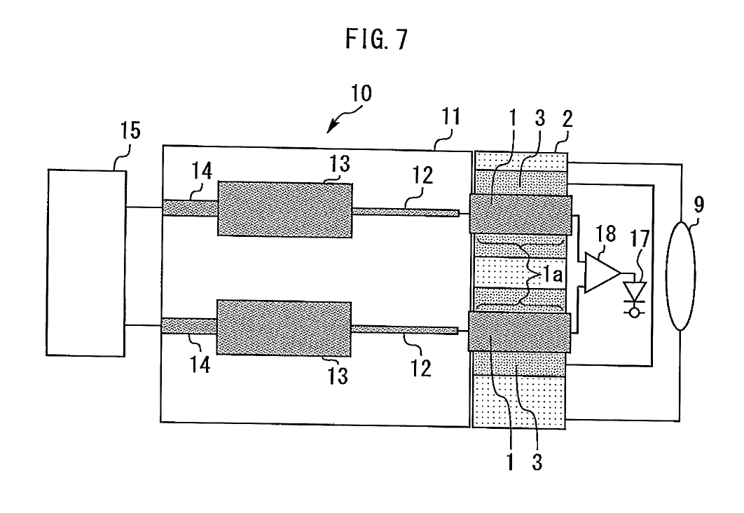

FIG. 7 is a diagram showing an optical module according to the third embodiment of the present invention. A light receiving element 17 and a preamplifier 18 are used in place of the electro-absorption optical modulator element 5 in the first embodiment. Since the light receiving element 17 and the preamplifier 18 normally do not require temperature control, they are directly formed on the metallic stem 2. Therefore, the electrical lengths between the lead pins 1 and the outputs of the preamplifier 18 are short. However, since the output impedance of the preamplifier 18 are normally close to 50Ω, the penetrating portions 1a of the lead pins 1 become impedance mismatching portions.

Therefore, in the third embodiment, the impedance of the signal lines 12 is made to be higher than matching impedance of 50Ω, and the impedance of the signal lines 13 is made to be lower than 50Ω. The impedance of the signal lines 14 and the terminating resistor of the driving circuit 15 are 50Ω.

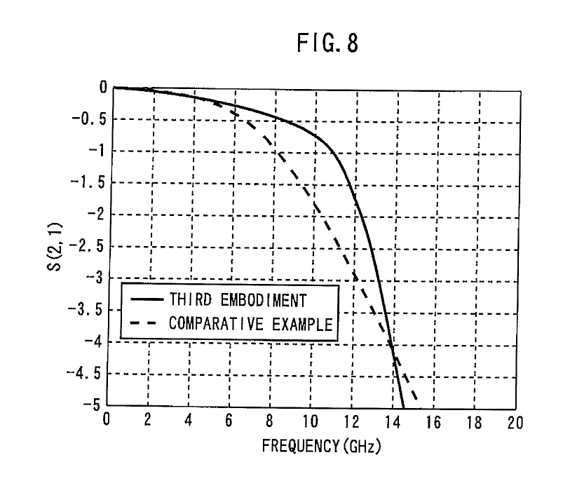

FIG. 8 is a graph showing the frequency dependency of S (2, 1) of optical modules of the third embodiment and the comparative example. The comparative example is an optical module from which signal line 12 and 13 are omitted. Since the electrical length to the output of the preamplifier 18 is short, no periodical swell occurs within frequencies of around 10 GHz. However, since the phases are weakened one another, the gain is lowered at 10 GHz in the comparative example. On the other hand, in the third embodiment, the gain at high frequencies can be improved. Therefore, favorable frequency response characteristics can be obtained.

### Fourth Embodiment

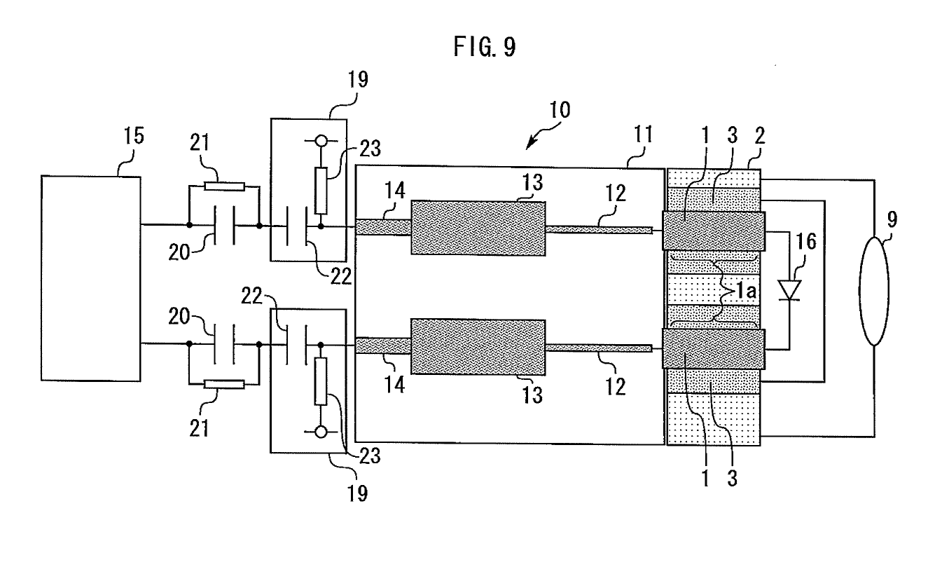

FIG. 9 is a diagram showing an optical module according to the fourth embodiment of the present invention. In this optical module, bias T circuits 19, capacitors 20, and resistors 21 are added to the configuration of the second embodiment.

The bias T circuits 19 have capacitors 22 connected between the other ends of signal lines 14 and the driving circuit 15, and resistors 23 connected between the other ends of signal lines 14 and bias terminals. Capacitors 20 are connected in series to the capacitors 22 in the bias T circuits 19. Resistors 21 are connected in series to the capacitors 22 in the bias T circuits 19, and connected in parallel to the capacitors 20.

Although the second embodiment can elevate the gain at high frequencies by overlapping two multiple reflections, the effect is low at low frequencies. Whereas by the present embodiment, the gain is lowered at low frequencies due to the effect of the resistor 21, and the gain elevates at high frequencies due to the decrease in the impedance of the capacitor 20. Therefore, the drop of gain from low frequency to 5 GHz can be compensated. In addition, since the resistor 21 is connected in series to the capacitor 22 of the bias T circuit 19 and thus the DC current does not flow through the resistor 21, heating values can be suppressed.

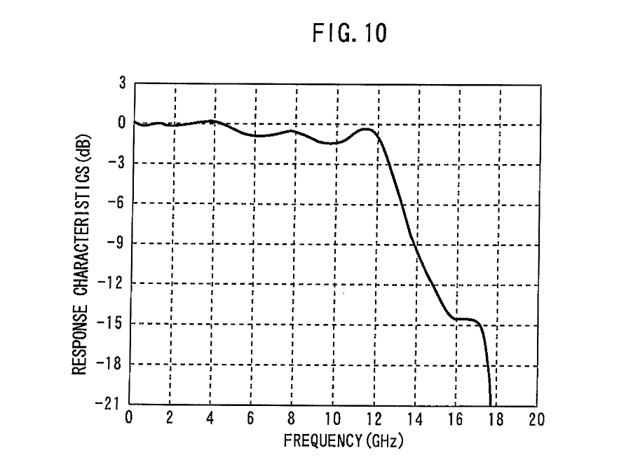

FIG. 10 is a graph showing the frequency dependency of response characteristics of an optical module according to the fourth embodiment of the present invention. As shown in the graph, ideal frequency response characteristics without drop of gain can be obtained up to 10 GHz.

### Fifth Embodiment

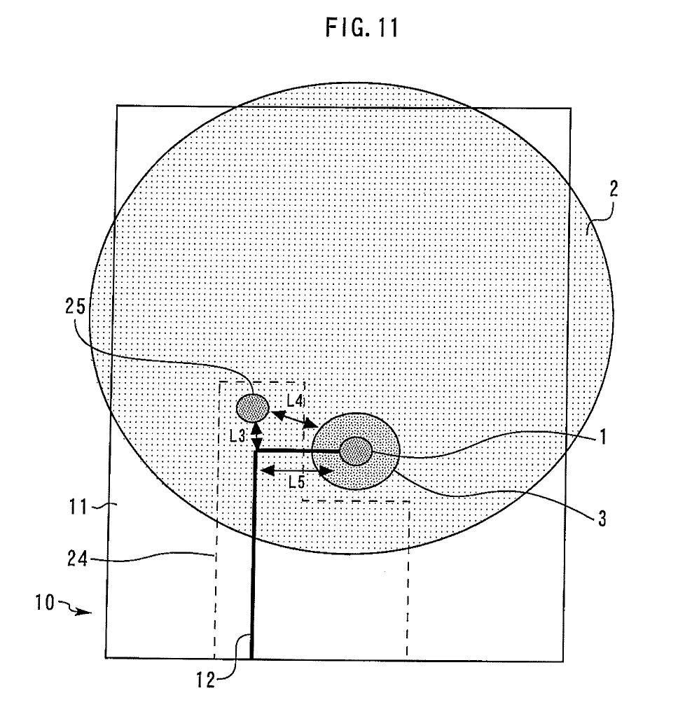

FIG. 11 is a diagram showing an optical module according to the fifth embodiment of the present invention. The signal lines of the flexible substrate 10 have a micro-strip line structure. Therefore, signal lines 12, 13, and 14 are formed on the surface of the base film 11, a grounding conductor 24 (AC-GND) is formed on the back face of the base film 11, and positioned apart from signal lines 12, 13, and 14.

An end of the signal line 12 is connected to the other end of the lead pin 1 with solder. The grounding conductor 24 is connected to the metallic stem 2 placed on the surface side of the base film 11 through a via 25 penetrating the base film 11.

The length of the grounding conductor 24 from the location nearest to the signal line 12 to the metallic stem 2 is L3. In other words, L3 is the sum of the length from the location of the grounding conductor 24 closest to the signal line 12 to the via 25 and length of the via 25. L4 is the length from the location where the grounding conductor 24 connects with the metallic stem 2 to the circumference of the penetrating portion 1a of the metallic stem 2. L5 is the length from the signal line 12 to the lead pin 1.

Here, the electric field of the electric modulation signals transferring through signal lines 12 and 13 is connected to the grounding conductor 24. Then, at the joining portion of the signal line 12 and the lead pin 1, the electric field of the electric modulation signals is connected to the metallic stem 2 at the periphery of the glass insulator 3. However, if the electrical length of GND becomes longer than the electrical length of the signals, frequency response characteristics are deteriorated. Although it is ideally desired that the both electrical lengths are equal, characteristic deterioration does not appear until approximately 10 GHz if the difference of the both is 500 μm or less. Therefore in the present embodiment, the difference of the sum of L3 and L4 with L5 (L3+L4−L5) is made to be 500 μm or less.

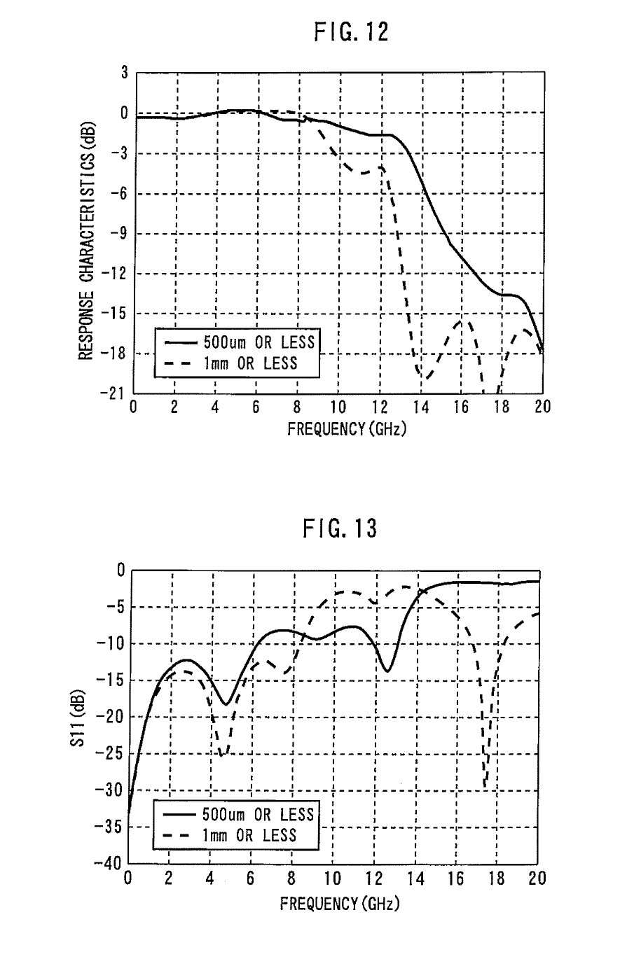

FIG. 12 is a graph showing the frequency dependency of the response characteristics of an optical module according to the fifth embodiment of the present invention. FIG. 13 is a graph showing the frequency dependency of the S11 of an optical module according to the fifth embodiment of the present invention. It can be seen that the deterioration of the frequency response characteristics is suppressed by shortening the difference of electric length between signals and GND.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2011-097180, filed on Apr. 25, 2011 including specification, claims, drawings and summary, on which the Convention priority of the present application is based, are incorporated herein by reference in its entirety.

1. An optical module comprising:
a metallic stem;
a lead pin penetrating through the metallic stem and electrically insulated from the metallic stem;
an optical semiconductor element on the metallic stem and connected to a first end of the lead pin; and
a flexible substrate including first and second signal lines having respective impedances, wherein
a first end of the first signal line is connected to a second end of the lead pin,
a second end of the first signal line is connected to a first end of the second signal line,
the lead pin has a penetrating portion penetrating through the metallic stem and having an impedance, and
each of the impedances of the penetrating portion and of the second signal line is smaller than the impedance of the first signal line.

2. The optical module according to claim 1, further comprising a driving circuit connected to a second end of the second signal line, wherein
the driving circuit includes a terminating resistor having an impedance,
each of the impedances of the penetrating portion and of the second signal line is smaller than the impedance of the terminating resistor of the driving circuit, and
the impedance of the first signal line is matched to the impedance of the terminating resistor of the driving circuit.

3. The optical module according to claim 2, further comprising a temperature controlling element located on the metallic stem, wherein the optical semiconductor element is located on the temperature controlling element.

4. The optical module according to claim 1, further comprising a driving circuit connected to a second end of the second signal line, wherein
the driving circuit includes a terminating resistor having an impedance,
the impedance of the first signal line is larger than the impedance of the terminating resistor of the driving circuit, and
the impedance of the second signal line is smaller than the impedance of the terminating resistor of the driving circuit.

5. The optical module according to claim 4, further comprising:
a bias T circuit connected to the second end of the second signal line;
a capacitor connected in series with the bias T circuit; and
a resistor connected in series with the bias T circuit and connected in parallel with the capacitor.

6. The optical module according to claim 1, wherein
the flexible substrate includes a grounding conductor positioned apart from the first and second signal lines and connected to the metallic stem,
the grounding conductor has a first length from a location nearest to the first signal line to the metallic stem, a second length from a location where the grounding conductor connects with the metallic stem to a circumference of the penetrating portion of the metallic stem, and a third length from the first signal line to the lead pin, and
the first length plus the second length minus the third length is no larger than 500 μm.
